(19) United States
(12) Patent Application Publication
(10) Pub. No.: US 2026/0368824 A1
(43) Pub. Date: Nov. 19, 2026

(54) COMPUTER SYSTEM AND METHOD FOR DETERMINING INSURANCE RATE CHANGES

(71) Applicant: Modives Enterprise LLC, Charlotte, NC (US)

(72) Inventors: Frederick Waite, Concord, NC (US); Justin Silver, Wyckoff, NJ (US); Joel Samen, Winchester, MA (US)

(73) Assignee: Modives Enterprise LLC, Charlotte, NC (US)

(21) Appl. No.: 19/210,648

(22) Filed: May 16, 2025

(51) Int. Cl. G06Q 40/08; G06Q 30/018; G06Q 30/0201; G06V 30/41

(52) U.S. Cl. CPC G06Q 40/08; G06Q 30/018; G06Q 30/0206; G06V 30/41

(57) ABSTRACT

A computer-implemented method and system for determining insurance rate changes preferably utilizing one or more Artificial Intelligence (AI) techniques. Captured in a computer processor is data associated with a user's insurance policy, which is then preferably analyzed by the computer processor to determine at least one policy identifier associated with the user's insurance policy. The computer processor captures, preferably from a third-party database, regulatory change request data associated with one or more insurance policies, responsive to the determined policy identifier associated with the user's insurance policy. The computer processor analyzes the captured change request data to determine one or more changes associated with the user's insurance policy. The computer processor then provides electronic notification to a user's device indicative of the determined one or more changes associated with the user's insurance policy.

### BACKGROUND

### 1. Field

Artificial Intelligence (AI) based system and apparatus for detected regulatory requested changes to one or more parameters of insurance policies, and more particularly to determining contemplated and/or actual changes to a user's insurance policies based upon detection and analysis of insurance regulatory data filings.

### 2. Description of Related Art

In the United States, state regulatory databases that contain data from insurance companies seeking rate increases are typically managed by state insurance departments. These databases are part of the rate filing process, where insurers submit their proposed rate changes for approval. The specific name and accessibility of these databases can vary by state, but they generally fall under the purview of the state's Department of Insurance or similar regulatory body. For example, many states use the System for Electronic Rate and Form Filing (SERFF), which is a tool developed by the National Association of Insurance Commissioners (NAIC). SERFF facilitates the electronic submission of insurance product filings, including rate changes, to state regulators.

Currently, there is no method and/or system providing notification to insurance consumers of changes (e.g., rate increases) to their insurance policies (e.g., automotive insurance) based upon regulatory filings by insurance companies seeking such changes, until they were notified by their insurance companies of the changes took effect. Nor are there any methods and/or systems providing notification to insurance consumers that another insurance carrier in their state filed for a decrease in auto insurance rates, which could positively affect them. For instance, a January 2024 survey by Motley Fool Money found that 26% of US respondents shop for a new auto insurance policy annually. This means approximately 3 out of 4 insurance consumers do not shop every single year and are unaware if an insurance carrier filed for a decrease in auto insurance rates.

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

In accordance with the illustrated embodiments, provided is preferably an AI based computer system that ingests third-party auto insurance rate change data submitted by insurance carriers to state departments of insurance across the entire United States. The AI based computer system is configured and operative to systematically communicate the impact of such rate changes to insurance consumers, both positive (rate increase) and negative (rate decrease). The AI based computer system preferably monitors the process for the insurance carrier rate change submission; from submission to negotiation with state departments of insurance, to revisions, to outcome (approve/disapprove), and if approved, the effective date of the rate change.

To achieve these and other advantages and in accordance with the purpose of the illustrated embodiments, in one aspect, described is a computer-implemented method and system for determining insurance rate changes preferably utilizing one or more Artificial Intelligence (AI) techniques. Captured in a computer processor is data associated with a user's insurance policy (e.g., an automative insurance policy), which is then preferably analyzed by the computer processor to determine at least one policy identifier associated with the user's insurance policy. The computer processor captures, preferably from a third-party database, regulatory change request data associated with one or more insurance policies (e.g., a request/filing for a change to insurance pricing), responsive to the determined policy identifier associated with the user's insurance policy. The computer processor analyzes the captured change request data to determine one or more changes associated with the user's insurance policy. The computer processor then provides electronic notification to a user's device indicative of the determined one or more changes associated with the user's insurance policy.

Thus, the illustrated embodiments for determining insurance rate changes based upon filed regulatory change requests using one or more AI techniques provides a technical improvement to a computer-controlled monitoring systems by automatically detecting filed regulatory requests for insurance policy premium pricing for determining corresponding future changes to user insurance policies.

### BRIEF DESCRIPTION OF THE DRAWINGS

So that those skilled in the art to which the subject disclosure appertains will readily understand how to make and use the devices and methods of the subject disclosure without undue experimentation, preferred illustrated embodiments thereof will be described in detail herein below with reference to certain figures, wherein:

FIG. 1 illustrates an example communication network utilized with one or more of the illustrated embodiments;

FIG. 2 illustrates an example network device/node utilized with one or more of the illustrated embodiments;

FIG. 3 illustrates a diagram depicting an Artificial Intelligence (AI) device utilized with one or more of the illustrated embodiments;

FIG. 4 illustrates a diagram depicting an AI server utilized with one or more of the illustrated embodiments;

FIG. 5 is a system level diagram in accordance with one or more of the illustrated embodiments; and

FIG. 6 is a flowchart a method of operation in accordance with one or more of the illustrated embodiments.

### DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this illustrated embodiment belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

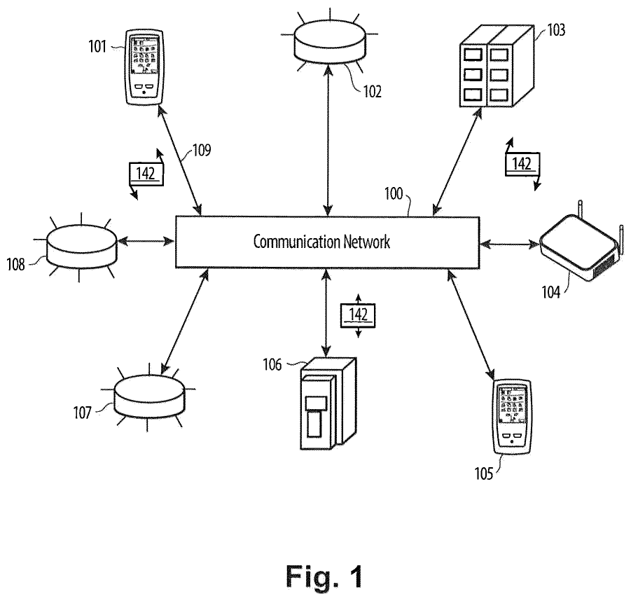

Turning now descriptively to the drawings, in which similar reference characters denote similar elements throughout the several views, FIG. 1 depicts an exemplary communications network 100 in which below illustrated embodiments may be implemented. It is to be understood a communication network 100 is a geographically distributed collection of nodes interconnected by communication links and segments for transporting data between end nodes, such as personal computers, work stations, smart phone devices, tablets, televisions, sensors and or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others.

FIG. 1 is a schematic block diagram of an example communication network 100 illustratively comprising nodes/devices 101-108 (e.g., Personal Digital Assistant (PDA) devices 101, sensors 102, computing devices 103, smart phone devices 105, web servers/computer systems 106, computer systems 107, switches 108, databases, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited and may be applied to networks that are hardwired.

As will be appreciated by one skilled in the art, aspects of the illustrated embodiments may be embodied as a system, method or computer program product. Accordingly, aspects of the illustrated embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the illustrated embodiments may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the illustrated embodiments may be written in any combination of one or more programming languages, including an object oriented programming language such as Python, Golang, Ruby, ASP. NET, Java,, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrated embodiments are described below with reference to flowchart illustrations and/or block diagrams of methods, apparatus (systems) and computer program products according to the illustrated embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

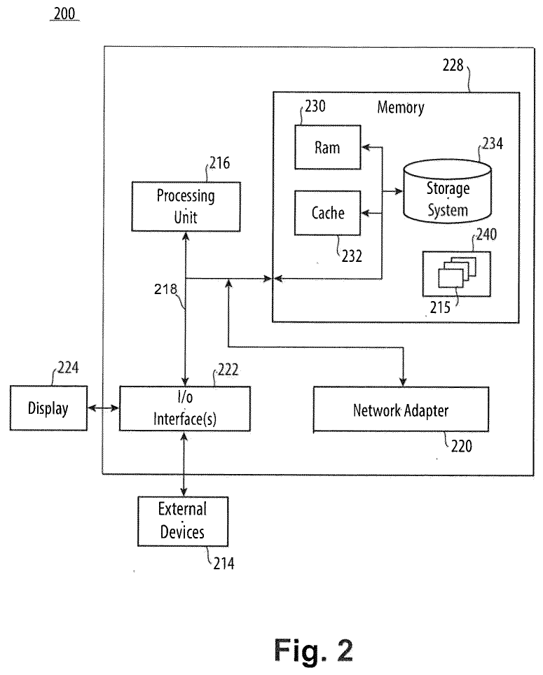

FIG. 2 is a schematic block diagram of an example network computing device 200 (e.g., client computing device 103, computer system 106, etc.) that may be used (or components thereof) with one or more embodiments described herein, e.g., as one of the nodes shown in the network 100. As explained above, in different embodiments these various devices are configured to communicate with each other in any suitable way, such as, for example, via communication network 100.

Device 200 is intended to represent any type of computer system capable of carrying out the teachings of various illustrated embodiments. Device 200 is only one example of a suitable system and is not intended to suggest any limitation as to the scope of use or functionality of the illustrated embodiments described herein. Regardless, computing device 200 is capable of being implemented and/or performing any of the functionality set forth herein, including a computer monitoring system 106.

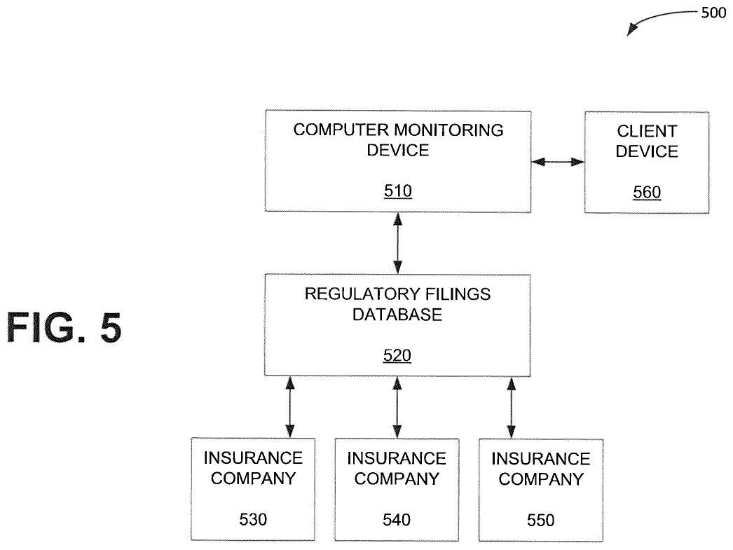

Computing device 200 is operational with numerous other general purpose or special purpose computing system environments or configurations. Examples of well-known computing systems, environments, and/or configurations that may be suitable for use with computing device 200 include, but are not limited to, cloud computing systems (including, but not limited to: Infrastructure as a Service (Iaas); Software as a Servuce (SaaS); Platform as a Service (PaaS); and Private cloud), personal computer systems, server computer systems, thin clients, thick clients, hand-held or laptop devices, multiprocessor systems, microprocessor-based systems, programmable consumer electronics, network PCs, minicomputer systems, and distributed data processing environments that include any of the above systems or devices, and the like. Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices. In accordance with the illustrated embodiments, computing device 200 is configured and operative, relative to a computer monitoring device 510 (FIG. 5, as described further below), to monitor and detect, filed regulatory requests for insurance policy premium pricing for determining corresponding future changes to user insurance policies, that is an intermediatory one or more client devices 560 and at least one regulatory database (e.g., 520) associated with future change requests for insurance policy premium pricing.

The components of device 200 may include, but are not limited to, one or more processors or processing units 216, a system memory 228, and a bus 218 that couples various system components including system memory 228 to processor 216. Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random-access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of illustrated embodiments.

Program/utility 240, having a set (at least one) of program modules 215, such as detection module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of the illustrated embodiments as described herein, including, but not limited to automatically detect filed regulatory requests for insurance policy premium pricing for determining corresponding future changes to user insurance policies.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: big data technologies encompassing large and diverse datasets that are significant in volume, which are commonly used in machine learning, predictive modeling, and other advanced analytics to solve business problems and make informed decisions; non-relational databases (NoSQLs); Blob storage; relational databases (SQL); as well as microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which the below described illustrated embodiments may be implemented. FIGS. 1 and 2 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

It is to be understood the embodiments described herein are preferably provided with self-learning/Artificial Intelligence (AI) to automatically detect filed regulatory requests for insurance policy premium pricing for determining corresponding future changes to user insurance policies, as described herein. In particular, one or more AI techniques are utilized to ingest rate filings from one or more insurance carriers, which may be via a third-party upload, to automatically pair rate changes and their impact to insuree consumers (e.g., 560). Thus, preferably integrated into a computer monitoring tool (e.g., device 510) coupled to a plurality of external databases/data sources is an AI system (e.g., an Expert System) that implements machine learning and artificial intelligence algorithms to conduct one or more of the above-mentioned insurance related tasks, preferably on an automated basis. For instance, the AI system may include two subsystems: a first sub-system that learns from historical and present insurance data preferably associated with regulatory filings; and a second subsystem to identify and recommend one or more parameters or approaches based on the learning. It should be appreciated that although the AI system may be described as two distinct subsystems, the AI system can also be implemented as a single system incorporating the functions and features described with respect to both subsystems.

In accordance with the illustrated embodiments described herein, artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

Also, in accordance with the illustrated embodiments, an artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value. The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function. The purpose of the learning of the artificial neural network may be to determine the model parameters that minimize a loss function. The loss function may be used as an index to determine optimal model parameters in the learning process of the artificial neural network. Machine learning may be classified into supervised learning, unsupervised learning, and reinforcement learning according to a learning method. The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

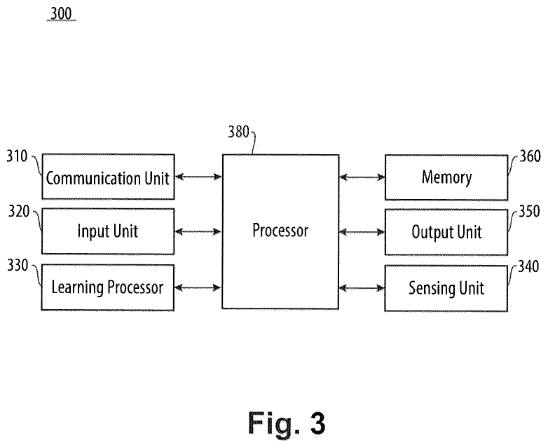

Machine learning, which is implemented as a deep neural network (DNN) including a plurality of hidden layers among artificial neural networks, is also referred to as deep learning, and the deep learning is part of machine learning. FIG. 3 illustrates an AI device 300 according to an illustrated embodiment. In accordance with the illustrated embodiments, the AI device 300 is preferably integrated into a computer device 510 for determining changes to insurance policies based upon filed regulatory requests for changing one or more parameters of an insurance policy (e.g., changes premium policy pricing).

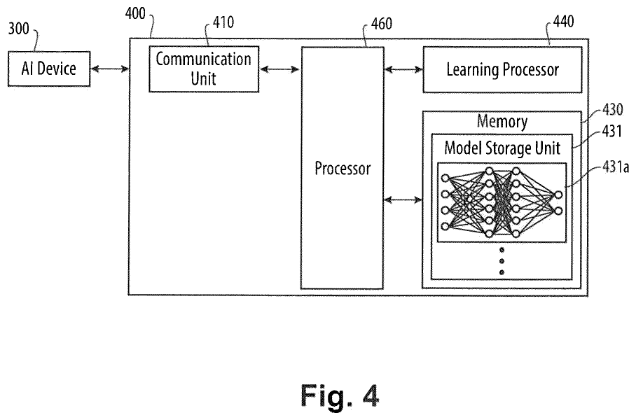

Referring now FIG. 3, in conjunction with FIGS. 1 and 2, the AI device 300 is operatively coupled to, or integrated with computing device 200, in accordance with the illustrated embodiments described herein. AI device 300 preferably includes a communication unit 310, an input unit 320, a learning processor 330, a sensing unit 340, an output unit 350, a memory 360, and a processor 380. The communication unit 310 may transmit and receive data to and from external devices such as other AI devices 300a to 300e and an AI server 400 (FIG. 4) by using wire/wireless communication technology. For example, the communication unit 310 may transmit and receive sensor information, a user input, a learning model, and a control signal to and from external devices.

The communication technology used by the communication unit 310 preferably includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 320 may acquire various kinds of data, including, but not limited to insurance data and data relating to insured clients (e.g., public record databases) (including, but not limited to regulatory insurance data associated with future pricing change requests). The input unit 320 may acquire a learning data for model learning and an input data to be used when an output is acquired by using the learning model. The input unit 320 may acquire raw input data. In this case, the processor 380 or the learning processor 330 may extract an input feature by preprocessing the input data. The learning processor 330 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 330 may perform AI processing together with the learning processor 330 of the AI server 400, and the learning processor 330 may include a memory integrated or implemented in the AI device 300. Alternatively, the learning processor 330 may be implemented by using the memory 360, an external memory directly connected to the AI device 300, or a memory held in an external device. The sensing unit 340 may acquire at least one of internal information about the AI device 300, ambient environment information about the AI device 300, and user information by using various sensors.

The output unit 350 preferably includes a display unit for outputting/displaying relevant information to a user in accordance with the illustrated embodiments described herein. The memory 360 preferably stores data that supports various functions of the AI device 300. For example, the memory 360 may store input data acquired by the input unit 320, learning data, a learning model, a learning history, and the like.

The processor 380 preferably determines at least one executable operation of the AI device 300 based on information determined or generated by using a data analysis algorithm or a machine learning algorithm. The processor 380 may control the components of the AI device 300 to execute the determined operation. To this end, the processor 380 may request, search, receive, or utilize data of the learning processor 330 or the memory 360. The processor 380 may control the components of the AI device 300 to execute the predicted operation or the operation determined to be desirable among the at least one executable operation. When the connection of an external device is required to perform a determined operation, the processor 380 may generate a control signal for controlling the external device and may transmit the generated control signal to the external device. The processor 380 may acquire intention information for the user input and may determine the user's requirements based on the acquired intention information. The processor 380 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 330, may be learned by the learning processor 340 of the AI server 400, or may be learned by their distributed processing. The processor 380 may collect history information including the operation contents of the AI device 300 or the user's feedback on the operation and may store the collected history information in the memory 360 or the learning processor 330 or transmit the collected history information to the external device such as the AI server 400. The collected history information may be used to update the learning model.

The processor 380 may control at least part of the components of AI device 300 so as to drive an application program stored in memory 360. Furthermore, the processor 380 may operate two or more of the components included in the AI device 300 in combination so as to drive the application program.

FIG. 4 illustrates an AI server 400 according to the illustrated embodiments. It is to be appreciated that the AI server 400 may refer to a device that learns an artificial neural network by using a machine learning algorithm or uses a learned artificial neural network. The AI server 400 may include a plurality of servers to perform distributed processing or may be defined as a 5G network. At this time, the AI server 400 may be included as a partial configuration of the AI device 300 and may perform at least part of the AI processing together. The AI server 400 may include a communication unit 410, a memory 430, a learning processor 440, a processor 460, and the like. The communication unit 410 can transmit and receive data to and from an external device such as the AI device 300. The memory 430 may include a model storage unit 431. The model storage unit 431 may store a learning or learned model (or an artificial neural network 431a) through the learning processor 440.

The learning processor 440 may learn the artificial neural network 431a by using the learning data. The learning model may be used in a state of being mounted on the AI server 400 of the artificial neural network or may be used in a state of being mounted on an external device such as the AI device 300. The learning model may be implemented in hardware, software, or a combination of hardware and software. If all or part of the learning models are implemented in software, one or more instructions that constitute the learning model may be stored in memory 430. The processor 460 may infer the result value for new input data by using the learning model and may generate a response or a control command based on the inferred result value.

With the exemplary communication network 100 (FIG. 1), computing device 200 (FIG. 2), AI device 300 (FIG. 3) and AI server 400 (FIG. 4) being generally shown and discussed above, description of certain illustrated embodiments will now be provided with below reference to FIG. 5. It is to be understood and appreciated that FIGS. 1-4 are intended to provide a brief, general description of an illustrative and/or suitable exemplary environment in which the below described illustrated embodiments may be implemented. FIGS. 1-4 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added.

With reference now to FIG. 5, shown is an exemplary generalized system 500, utilizing one or more of the components of the aforementioned communication networks 100 (FIG. 1), computing device 200 (FIG. 2), AI device 300 (FIG. 3) and AI server 400 (FIG. 4), depicting one or more illustrated embodiments for detecting filed regulatory requests for changes to insurance policies, such as a change in policy premium pricing, for determining corresponding future changes to one or more of a user's insurance policies.

As shown in FIG. 5, system 500 includes a computer monitoring device 510 coupled, via a computer network (e.g., 100), to one or more regulatory databases (e.g., 520) have data associated with filings from preferably a plurality of insurance providers (e.g., 530, 540, 550). The data filings from the insurance providers (e.g., 530, 540, 550) preferably include data indicative of a requested future changes to insurance policy, such as insurance premium pricing (e.g., a regulatory filing for a premium rate increase for insurees in a certain state). It is to be understood an “insuree” is a person or entity whose property (e.g., a vehicle) or interests are covered by an insurance policy. Also communicatively coupled to the computer monitoring device 510 is preferably one or more client devices (e.g., 560), wherein each client device 560 is associated with one or more insurees seeking to be informed of any prospective insurance rate increases to one or more of their insurance policies in view of an aforesaid regulatory filing seeking to increase insurance policy premium pricing. It is noted, that computer monitoring device 510 is also preferably configured and operative to provide a monitoring service to one or more user's 560 for automatically, and preferably on a periodic basis, detect an actual, or requested, rate change to one or more of their insurance policies based upon automatic detection of an aforesaid regulatory filing seeking to increase insurance policy premium pricing. As described further below, once detected, the computer monitoring device 510 is further preferably configured and operative to provide electronic notification of the detected rate change to the user's computing device (e.g., 560), as well as to determine alternative insurance providers offering comparable insurance policies, preferably at a reduced rate comparative to an insuree's current insurance policy which is subject to the determined rate increase.

It is to be appreciated and understood that while certain illustrated embodiments are described herein relative to making determinations on automative insurance policies, the illustrated embodiments are not to be limited thereto as they may likewise include different applicable insurance policy types requiring regulatory approval for changes thereupon, such as (but not limited to): health insurance, homeowners insurance, life insurance, property and casualty insurance, workers'compensation insurance, and Medicare supplement insurance).

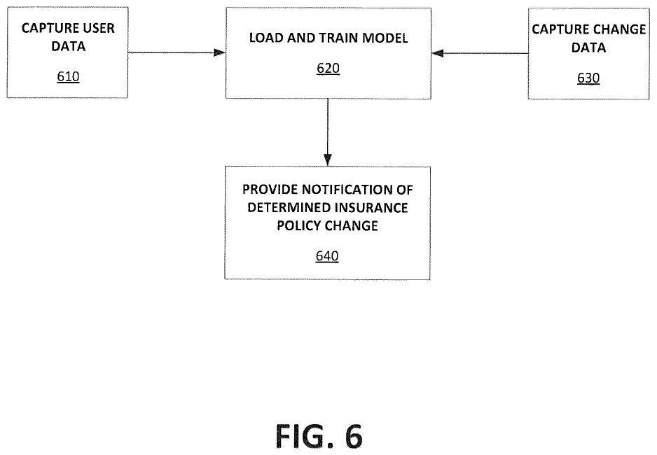

With the exemplary communication network 100 (FIG. 1), computing device 200 (FIG. 2), AI device 300 (FIG. 3), AI server 400 (FIG. 4), and computer system 500 being generally shown and discussed above, with reference now to FIG. 6, shown is an exemplary process 600, utilizing one or more of the aforementioned components of the communication network 100 (FIG. 1), computing device 200 (FIG. 2), AI device 300 (FIG. 3) AI server 400 (FIG. 4), and computer system 500, in accordance with one or more illustrated embodiments

Starting at step 610, captured (ingested) in the computer monitoring device 510, preferably via a computer network 100, is data associated with one or more user's insurance policies. For ease of description, reference herein will be provided relative to a user's single insurance policy, with the type being an automotive insurance policy. However, the illustrated embodiments are not to be limited thereto, as the illustrated embodiments may encompass capturing and analyzing data from a plurality of insurance companies associated with one or more users. Additionally, the insurance policies subject to analyzation by computer system 500 and computer method 600 are not to be limited to automative insurance policies but may encompass other types of insurance policies (as mentioned above) subject to requiring regulatory approval for pricing changes, such as (but not limited to) health insurance, homeowners insurance, life insurance, property and casualty insurance, workers'compensation insurance, and Medicare supplement insurance.

In accordance with the illustrated embodiments, capturing data associated with a user's insurance policy may include user entry of data in a user's computer device 560 communicatively coupled (via network 100) to the computer monitoring device 510. Additionally, capturing data associated with a user's insurance policy may include the computer monitoring device 510 being configured and operative to perform one or more Optical Character Recognition (OCR) techniques on user provided documents (such as insurance cards, insurance policy documents), preferably inputted via a user's computer device 560.

Next, at step 620, the computer monitoring device 510 analyzes the captured insurance policy data (step 610) in a trained ML model to determine at least one policy identifier associated with the user's insurance policy (e.g., name of insurance company and insurance policy no.). In accordance with the illustrated embodiments, the computer monitoring device 510 is configured and operative to load, and train, a ML model (as described above, FIGS. 3 and 4) for performing one of more of the functionalities and/or probabilistic determinations described herein, using one or more AI techniques, such as to determine the least one policy identifier and an insurance policy associated with the policy identifier.

Once the user's policy information is identified (step 620), next at step 630, captured preferably via a computer network 100, in the computer monitoring device 510, is rate change data from one or more third-party databases 520, responsive to the determined policy identifier associated with the user's insurance policy. In accordance with certain illustrated embodiments, capturing rate change data includes capturing from one or more third-party databases, insurance rate change data submitted by one or more insurance carriers (e.g., 530, 540 and 550). Additionally, the one or more databases 520 are preferably associated with a government insurance regulatory agency, as mentioned above. In accordance with the illustrated embodiments, the computer monitoring device 510 is further configured and operative to load, and train, the ML model (as mentioned above with respect to step 620) for using one or more AI techniques to additionally determine insurance policy rate changes for the insurance policy associated with the determined at least one policy identifier, from the one or more third-party databases 520.

Once the computer monitoring device 510 determines the least one policy identifier and insurance policy rate changes for the insurance policy associated with the determined at least one policy identifier, the computer monitoring device 510 analyzes, using the aforesaid trained ML model (step 620), the captured rate change data (step 630) to determine one or more rate changes associated with the user's insurance policy. In accordance with the illustrated embodiments, this is preferably performed using one or more AI techniques in the trained ML model. It is to be understood and appreciated that with regards to using AI techniques for each of the aforementioned determinations, the one or more AI techniques for performing each determination may consist of one or more of supervised learning techniques, unsupervised learning techniques, Natural Language Processing (NLP) techniques, Neural Networks (NN), and Convolutional Neural Networks, and computer vision techniques.

In accordance with the illustrated embodiments, determining one or more rate changes associated with the user's insurance policy includes identifying a submission from an insurance carrier (e.g., 530, 540, and 550) to a regulatory agency (e.g., 520) for a request to increase an insurance premium rate. Further, determining one or more rate changes associated with the user's insurance policy may include monitoring a process in the regulatory agency (520) regarding rate change submission from one or more insurance carriers (e.g., 530, 540, and 550). Additionally, determining one or more rate changes associated with the user's insurance policy may further include determining one or more alternative insurance carriers (e.g., 530, 540 and 550) which can provide an insurance policy to the user at a rate lower than the requested increase to the insurance premium rate associated with the user's insurance policy, wherein determining one or more alternative insurance carriers may include determining one or more AI confidence score values representative of the applicability of the determined one or more alternative insurance carriers relative to the user's insurance policy. For instance, the one or more AI confidence score values may consist of a: probability score; softmax score, logistic regression score and confidence intervals. Preferably, the one or more AI confidence score values are determined using a: softmax function, bayesian method, ensemble method, calibration technique, monte carlo dropout technique, and quantile regression technique.

Proceeding to step 640 in process 600, the computer monitor device 510 is configured and operative to provide electronic notification to a user's device (e.g., 560) indicative of the determined one or more rate changes associated with the user's insurance policy. In accordance with certain illustrated embodiments, the electronic notification preferably includes indication of the identified submission from an insurance carrier (e.g., 530, 540 and 550) to a regulatory insurance agency (e.g., 520) for a request to increase an insurance premium rate. In accordance with additionally illustrated embodiments, the computer monitoring device 510 is configured and operative to include in the electronic notification indication of determined one or more alternative insurance carriers.

With regards to each of the aforesaid steps (e.g., 610-640), in certain illustrated embodiments, the steps of: capturing rate change data (step 630), analyzing the captured rate change data (step 620) and providing electronic notification (640), are automatically performed by the computer monitoring device 510 in predetermined time intervals (e.g., on a monthly basis). For instance, a user (e.g., 560) may subscribe to a computerized automated insurance change monitoring service provided by the computer monitoring device 510 so that on a periodic basis (e.g., monthly), it electronically monitors for any requested changes, or actual changes, affecting one or more of the user's insurance policy based on electronic regulatory submissions provided by insurance companies (e.g., 530, 540 and 550) to a governmental regulatory insurance agency (e.g., 520), as described above.

Thus, the illustrated embodiments for determining insurance rate changes based upon filed regulatory change requests using one or more AI techniques provides a technical improvement to a computer-controlled monitoring systems by automatically detecting filed regulatory requests for insurance policy changes for determining corresponding future changes to user insurance policies.

With certain illustrated embodiments described above, it is to be appreciated that various non-limiting embodiments described herein may be used separately, combined or selectively combined for specific applications. Further, some of the various features of the above non-limiting embodiments may be used without the corresponding use of other described features. The foregoing description should therefore be considered as merely illustrative of the principles, teachings and exemplary embodiments of the illustrated embodiments, and not in limitation thereof.

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. A computer-implemented method for determining insurance rate changes, comprising:
capturing, in a computer processor, data associated with a user's insurance policy;
analyzing, in the computer processor, the captured insurance policy data to determine at least one policy identifier associated with the user's insurance policy;
capturing, in the computer processor, rate change data from a third-party database, responsive to the determined policy identifier associated with the user's insurance policy;
analyzing, in the computer processor, the captured rate change data to determine one or more rate changes associated with the user's insurance policy; and
providing, by the computer processor, electronic notification to a user's device indicative of the determined one or more rate changes associated with the user's insurance policy.

2. The computer-implemented method as recited in claim 1, wherein the analyzing steps are performed using one or more Artificial Intelligence (AI) techniques.

3. The computer-implemented method as recited in claim 2, wherein the AI techniques consist of one or more of supervised learning techniques, unsupervised learning techniques, Natural Language Processing (NLP) techniques, Neural Networks (NN), and Convolutional Neural Networks, and computer vision techniques.

4. The computer-implemented method as recited in claim 1, wherein capturing data associated with a user's insurance policy includes user entry of data in a user's computer device communicatively coupled to the processor.

5. The computer-implemented method as recited in claim 4, wherein capturing data associated with a user's insurance policy further includes performing one or more Optical Character Recognition (OCR) techniques on user provided documents [e.g., insurance cards, insurance policy documents, etc.].

6. The computer-implemented method as recited in claim 1, wherein capturing rate change data includes capturing from one or more third-party databases, insurance rate change data submitted by one or more insurance carriers.

7. The computer-implemented method as recited in claim 6, wherein the one or more databases are associated with a government agency.

8. The computer-implemented method as recited in claim 1, wherein determining one or more rate changes associated with the user's insurance policy includes identifying a submission from an insurance carrier to a regulatory agency for a request to increase an insurance premium rate.

9. The computer-implemented method as recited in claim 8, wherein determining one or more rate changes associated with the user's insurance policy further includes monitoring a process in the regulatory agency regarding rate change submission from one or more insurance carriers.

10. The computer-implemented method as recited in claim 8, wherein determining one or more rate changes associated with the user's insurance policy further includes, responsive to identifying the submission for a request to increase an insurance premium rate, determining one or more alternative insurance carriers which can provide an insurance policy to the user at a rate lower than the requested increase to the insurance premium rate associated with the user's insurance policy.

11. The computer-implemented method as recited in claim 10, wherein determining one or more alternative insurance carriers includes determining one or more AI confidence score values representative of the applicability of the determined one or more alternative insurance carriers relative to the user's insurance policy.

12. The computer-implemented method as recited in claim 10, wherein the one or more AI confidence score values consists of a: probability score; softmax score, logistic regression score and confidence intervals.

13. The computer-implemented method as recited in claim 12, wherein the one or more AI confidence score values are determined using a: softmax function, bayesian method, ensemble method, calibration technique, monte carlo dropout technique, and quantile regression technique.

14. The computer-implemented method as recited in claim 8, wherein the electronic notification includes indication of the identified submission from an insurance carrier to a regulatory agency for a request to increase an insurance premium rate.

15. The computer-implemented method as recited in claim 10, wherein the electronic notification includes indication of the determined one or more alternative insurance carriers.

16. The computer-implemented method as recited in claim 1, wherein the steps of: capturing rate change data, analyzing the captured rate change data and providing electronic notification, are automatically performed by the processor in predetermined time intervals.

17. The computer-implemented method as recited in claim 1, wherein the user's insurance policy is an automative insurance policy.

18. The computer-implemented method as recited in claim 1, wherein the user's insurance policy consists of one or more of: health insurance, automative insurance, homeowners insurance, life insurance, property and casualty insurance, workers'compensation insurance, and Medicare supplement insurance.

19. An Artificial Intelligence (AI) based computer system for determining one or more changes to users'insurance policies, comprising:
a memory configured to store instructions;
a processor disposed in communication with the memory and coupled to a computer network, wherein the processor generates a learning inference model using a machine learning or deep learning algorithm being configured to:
capture, in a computer processor, data associated with a user's insurance policy;
analyze, in the computer processor, utilizing one or more AI techniques, the captured insurance policy data to determine at least one policy identifier associated with the user's insurance policy;
capture, in the computer processor, utilizing one or more AI techniques, requested change data to one or more insurance policies from a third-party database, responsive to the determined policy identifier associated with the user's insurance policy;
analyzing, in the computer processor, the captured rate change data to determine one or more changes associated with the user's insurance policy; and
providing, by the computer processor, electronic notification to a user's device indicative of the determined one or more changes associated with the user's insurance policy.

20. The AI based computer system as recited in claim 1, wherein the user's insurance policy is an automative insurance policy, and the captured requested change data relates to one or more requested pricing changes to automative insurance policies.
